(19) United States
(12) Patent Application Publication
(10) Pub. No.: US 2011/0096095 A1
(43) Pub. Date: Apr. 28, 2011

(54) DISPLAY DEVICE AND METHOD FOR ADJUSTING IMAGE ON DISPLAY SCREEN OF THE SAME

(75) Inventor: Zhong Xu, Shenzhen City (CN)

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/636,796

(22) Filed: Dec. 14, 2009

(30) Foreign Application Priority Data
Oct. 26, 2009 (CN) 200910308830.X

(51) Int. Cl. G09G 5/00

(52) U.S. Cl. 345/657; 348/78

(57) ABSTRACT

A display device includes a display screen, an image capturing device, a calculating module, and an image adjusting module. The display screen is capable of displaying an image thereon, and includes a first side. The image capturing device captures an image of a viewer, and includes an image sensor with a second side parallel to the first side. The calculating module identifies a left eye image and a right eye image of the viewer from the image of the viewer, and calculates an angle formed between the first side of the display screen and an imaginary straight line passing through the actual left eye and right eye of the viewer. The image adjusting module rotates the image on the display screen to make the first side of the display screen parallel to the imaginary straight line passing through the actual left eye and right eye of the viewer.

### BACKGROUND

1. Technical Field

The present disclosure relates to display devices and, particularly, to a display device which can automatically adjust an image on a display screen.

2. Description of Related Art

Typically, a display screen of the display device displays images with fixed direction, such as horizontally or vertically. Therefore, if the head of the viewer is tilted with respect to the image, it would be difficult for the user to read or interpret what is being displayed.

What is needed, therefore, is a display device which can automatically adjust image on a display screen thereof according to a tilt angle of a head of a viewer to overcome or at least mitigate the above-described problem.

### BRIEF DESCRIPTION OF THE DRAWINGS

Many aspects of the present display device and method for adjusting image on a display screen thereof can be better understood with reference to the accompanying drawings. The components in the drawings are not necessarily drawn to scale, the emphasis instead being placed upon clearly illustrating the principle of the present display device and method for adjusting image on a display screen thereof. In the drawings, all the views are schematic.

FIG. 1 is a schematic, functional block diagram of a display device according to an exemplary embodiment.

FIG. 2 is an image including a facial image of a viewer captured by an image capturing device of the display device of FIG. 1.

FIG. 3 is a schematic view of a display screen of the display device of FIG. 1 with an image displayed thereon before being adjusted.

FIG. 4 is a schematic view of the display screen of FIG. 4 with an image displayed thereon after being adjusted.

FIG. 5 is a flow chart of a method for adjusting image on the display screen of the display device of FIG. 1 according to an exemplary embodiment.

### DETAILED DESCRIPTION

Embodiments of the present disclosure will now be described in detail below, with reference to the accompanying drawings.

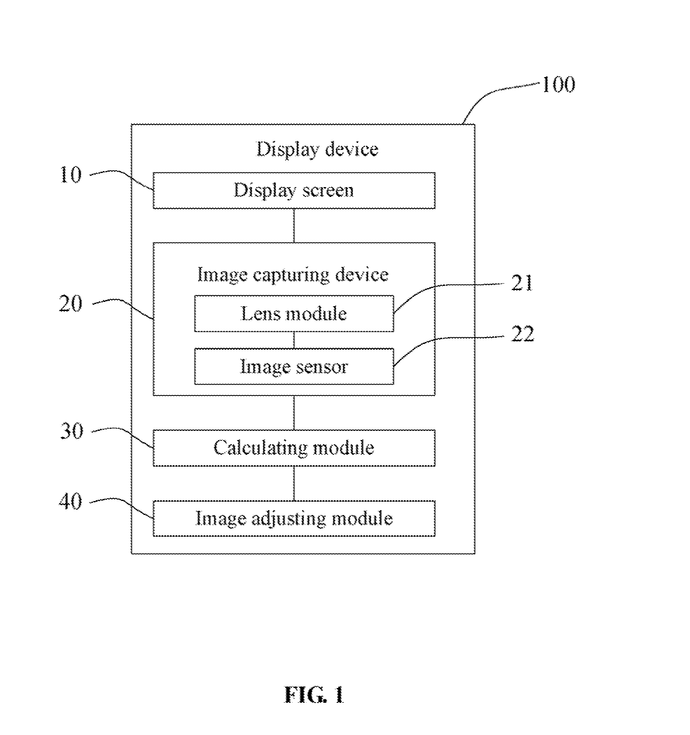

Referring to FIG. 1, a display device 100 according to an exemplary embodiment, is shown. The display device 100 includes a display screen 10, an image capturing device 20, a calculating module 30, and an image adjusting module 40. The display device 100 can be a digital still camera, a video camera, a notebook computer, a television etc.

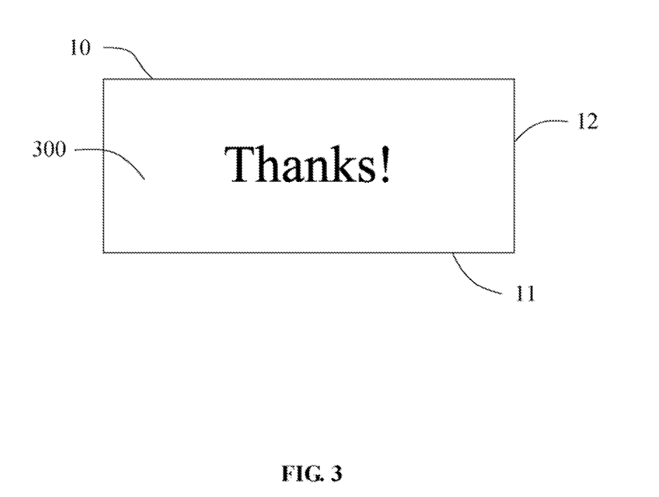

The display screen 10 can be a liquid crystal display screen, a plasma display screen, a cathode-ray tube display screen and so on. Referring to FIG. 3, the display screen 10 is rectangular, and has two opposite longer sides 11 and two opposite shorter sides 12 correspondingly.

The image capturing device 20 is configured for capturing an image of a viewer of the display device 100. The image capturing device 20 includes a lens module 21 and an image sensor 22 disposed behind the lens module 21. The image sensor 22 is rectangular, and has two opposite longer sides (not shown) and two opposite shorter sides (not shown). The longer side of the image sensor 22 is parallel to the longer side 11 of the display screen 10, and the shorter side of the image sensor 22 is parallel to the shorter side 12 of the display screen 10.

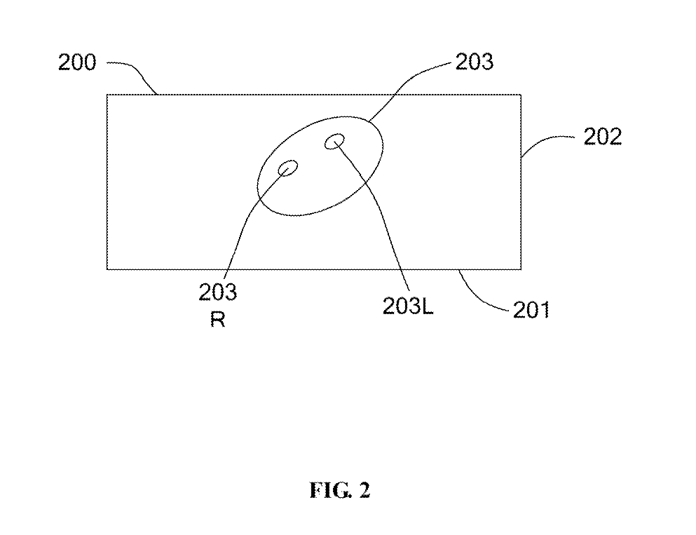

Referring to FIG. 2, an image 200 captured by the image sensor 22 is shown. The image 200 includes two longer image border 201 corresponding to the two longer sides of the image sensor 22, and two shorter image border 202 corresponding to the two shorter sides of the image sensor 22. The image 200 includes a facial image 203 of a viewer. The face image 203 includes a left eye image 203L and a right eye image 203R. The calculating module is configured for identifying the left eye image 203L and the right eye image 203R of the face image 23, and configured for calculating a first angle formed between the longer image border 201 and an imaginary straight line passing through the left eye image 203L and the right eye image 203R. Because the longer side and the shorter side of the image sensor 22 are parallel to the longer side 11 and the shorter side 12 of the display screen 10, respectively, a second angle formed between the longer side 11 of the display screen 10 and an imaginary straight line passing through the actual left eye and right eye of the viewer can be calculated according to the first angle. The value of the second angle is equal to that of the first angle, but the direction of the second angle is opposite to that of the first angle. Here, the direction of the second angle is opposite to that of the first angle means that one of the first angle and the second angle is positive angle, and the other is negative angle.

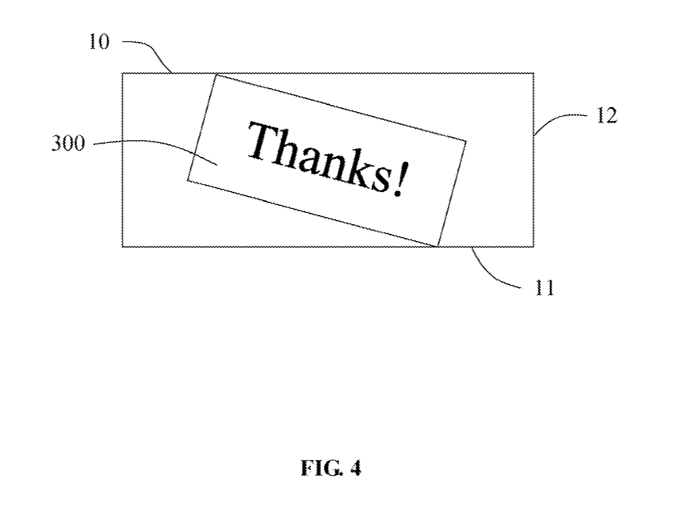

Referring to FIG. 3 and FIG. 4, the image adjusting module 40 is configured for rotating the image 300 on the display screen 10 with a rotation angle equal to the second angle. Therefore, the text, words etc. in the image 300 can be parallel to the imaginary straight line passing through the actual left and right eyes of the viewer, thus, the viewer can look the image on the display screen 10 comfortably. In order that the entire adjusted image 300 can be shown on the display screen 10, the image adjusting module 40, preferably, can also be able to enlarge and reduce the size of the image 300 on the display screen 10.

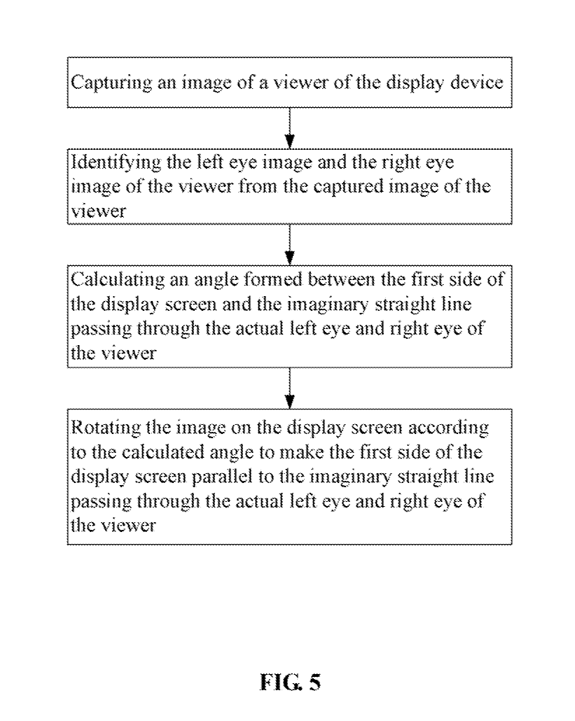

Referring to FIG. 5, a method for adjusting image 300 on the display screen 10 of the display device 100 is also provided. The method includes the steps of: capturing an image of a viewer of the display device 100; identifying the left eye image 203L and the right eye image 203R of the viewer from the captured image of the viewer; calculating an angle formed between the longer side 11 of the display screen 10 and the imaginary straight line passing through the actual left eye and right eye of the viewer; and rotating the image 300 on the display screen 10 according to the calculated angle to make the longer side 11 of the display screen 10 parallel to the imaginary straight line passing through the actual left eye and right eye of the viewer.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A display device comprising:
a display screen capable of displaying an image thereon, the display screen comprising a first side;
an image capturing device for capturing an image of a viewer, the image capturing device comprising an image sensor comprising a second side parallel to the first side of the display screen;
a calculating module configured for identifying a left eye image and a right eye image of the viewer from the image of the viewer captured by the image capturing device to calculate an angle formed between the first side of the display screen and an imaginary straight line passing through the actual left eye and right eye of the viewer; and
an image adjusting module configured for rotating the image on the display screen with a rotation angle equal to the calculated angle to make the first side of the display screen parallel to the imaginary straight line passing through the actual left eye and right eye of the viewer.

2. The display device of claim 1, wherein the display device is selected from a group consisting of a digital still camera, a video camera, a notebook computer, and a television.

3. The display device of claim 1, wherein the display screen is a liquid crystal display screen, a plasma display screen, or a cathode-ray tube display screen.

4. The display device of claim 1, wherein the display screen is rectangular, and comprises two opposite longer sides and two opposite shorter sides, the first side of the display screen is one of the two longer sides of the display screen.

5. The display device of claim 1, wherein the image sensor is rectangular, and comprises two opposite longer sides and two opposite shorter sides, the second side of the image sensor is one of the two longer sides of the image sensor.

6. The display device of claim 1, wherein the angle formed between the first side of the display screen and the imaginary straight line passing through the actual left eye and right eye of the viewer is calculated according to an angle formed between the second side of the image sensor and an imaginary straight line passing through the left eye image and the right eye image.

7. The display device of claim 6, wherein the value of the angle formed between the first side of the display screen and the imaginary straight line passing through the actual left eye and right eye of the viewer is equal to the value of the angle formed between the second side of the image sensor and the imaginary straight line passing through the left eye image and the right eye image.

8. The display device of claim 6, wherein the direction of the angle formed between the first side of the display screen and the imaginary straight line passing through the actual left eye and right eye of the viewer is opposite to the direction of the angle formed between the second side of the image sensor and the imaginary straight line passing through the left eye image and the right eye image.

9. The display device of claim 1, wherein the image adjusting module is capable of enlarging and reducing the size of the image on the display screen.

10. A method for adjusting image on a display screen of a display device, the display screen capable of displaying an image and comprising a first side, the display device comprising an image capturing device which comprises an image sensor comprising a second side parallel to the first side of the display screen, the method comprising:
capturing an image of a viewer of the display device;
identifying a left eye image and the right eye image of the viewer from the captured image of the viewer;
calculating an angle formed between the first side of the display screen and the imaginary straight line passing through the actual left eye and right eye of the viewer; and
rotating the image on the display screen according to the calculated angle to make the first side of the display screen parallel to the imaginary straight line passing through the actual left eye and right eye of the viewer.

11. The method of claim 10, wherein the angle formed between the first side of the display screen and the imaginary straight line passing through the actual left eye and right eye of the viewer is calculated according to an angle formed between the second side of the image sensor and an imaginary straight line passing through the left eye image and the right eye image.

12. The method of claim 11, wherein the value of the angle formed between the first side of the display screen and the imaginary straight line passing through the actual left eye and right eye of the viewer is equal to the value of the angle formed between the second side of the image sensor and the imaginary straight line passing through the left eye image and the right eye image.

13. The method of claim 11, wherein the direction of the angle formed between the first side of the display screen and the imaginary straight line passing through the actual left eye and right eye of the viewer is opposite to the direction of the angle formed between the second side of the image sensor and the imaginary straight line passing through the left eye image and the right eye image.

14. The method of claim 10, further comprising enlarging or reducing the size of the image on the display screen.
